(19) United States
(12) Patent Application Publication
(10) Pub. No.: US 2012/0326662 A1
(43) Pub. Date: Dec. 27, 2012

(54) NON-CONTACT POWER SUPPLY DEVICE, NON-CONTACT POWER RECEIVING DEVICE, AND NON-CONTACT POWER CHARGING SYSTEM

(76) Inventors: Takaoki Matsumoto, Shiga-ken (JP); Atsushi Isaka, Shiga-ken (JP); Kazuhiro Suzuki, Shiga-ken (JP); Kyohei Kada, Kyoto (JP); Yoshihide Kanakubo, Osaka (JP); Yohei Nagatake, Kanagawa-ken (JP); Kazuyo Ohta, Chiba-ken (JP)

(21) Appl. No.: 13/582,386

(22) PCT Filed: Mar. 8, 2011
(86) PCT No.: PCT/JP2011/055341

§ 371 Date: Aug. 31, 2012

(30) Foreign Application Priority Data
Apr. 19, 2010 (JP) 2010-096125

(51) Int. Cl. H02J 7/04; H01F 38/14

(52) U.S. Cl. 320/108; 307/104

(57) ABSTRACT

A contactless power transmitting device is provided with: a primary coil that can be magnetically coupled with a secondary coil of a contactless power receiving device; a first temperature sensor that detects the ambient temperature of the primary coil; a second temperature sensor that detects the temperature at a different location to the first temperature sensor; and a control unit. The control unit is configured to determine whether a value obtained by subtracting the temperature detected by the second temperature sensor from the ambient temperature of the first coil detected by the first temperature sensor exceeds a predetermined threshold value, and to stop the power to the first coil when the subtracted value exceeds the threshold value.

### TECHNICAL FIELD

The present invention relates to a contactless power transmitting device, a contactless power receiving device, and a contactless charging system that uses electromagnetic induction to transmit power between devices in a contactless manner.

### BACKGROUND ART

A contactless power transmitting device has recently become widely known as a device that can charge a rechargeable cell (battery) incorporated in a portable device, such as a cellular phone or a digital camera. Such a portable device and a charger (power transmitting device) corresponding to the portable device each include a coil that transfers charging power. AC power is transmitted from the charger to the portable device by electromagnetic induction between the two coils. The portable device converts the AC power into DC power to charge a rechargeable battery, which is a power supply of the portable device.

The transmission of power during such contactless charging generates high-frequency magnetic flux from the power transmitting coil. When a metal foreign object is present in the proximity of the power transmitting coil, the high-frequency magnetic flux generates eddy current that flows to the metal foreign object. This heats the metal foreign object and affects the power transmitting device. Thus, means for detecting a metal foreign object that is present in the proximity of a coil have been developed (for example, patent document 1 and patent document 2). One example of a prior art power transmitting device detects when the temperature of the power transmitting device, which is heated by a metal foreign object, exceeds a predetermined threshold and stops charging before the power transmitting device is affected by heat.

### PRIOR ART DOCUMENTS

### Patent Documents

Patent Document 1: Japanese Laid-Open Patent Publication No. 2003-153457
Patent Document 2: Japanese Laid-Open Patent Publication No. 2009-022126

### SUMMARY OF THE INVENTION

### Problems that are to be Solved by the Invention

However, the temperature detection in the prior art does not correspond to changes in the temperature of the usage environment. For example, in a cold environment such as during the winter, the ambient temperature is low. Thus, the difference between the temperature at the proximity of the coil and the threshold becomes large in a normal state. In such a case, the coil proximity temperature increased by the presence of a metal foreign object does not easily exceed the threshold, and charging is not easily stopped. That is, the detection accuracy of a metal foreign object becomes insufficient depending on the usage environment, and current is not properly cut. In this case, eddy current flows to the metal foreign object and adversely affects power transmission.

It is an object of the present invention to provide a contactless power transmitting device, contactless power receiving device, and contactless power charging system that can detect a metal foreign object without being affected by the usage environment.

### Means for Solving the Problems

One aspect of the present invention provides a contactless power transmitting device that supplies power in a contactless manner to a contactless power receiving device. The contactless power transmitting device includes a primary coil that generates alternating magnetic flux. The primary coil can be electromagnetically coupled by the alternating magnetic flux to a secondary coil of the contactless power receiving device. A first temperature sensor detects a primary coil proximity temperature. A second temperature sensor detects a temperature at a position that differs from where the first temperature sensor is located. A control unit determines whether or not a value obtained by subtracting the temperature detected by the second temperature sensor from the primary coil proximity temperature detected by the first temperature sensor exceeds a predetermined threshold. The control unit stops supplying power to the primary coil or issues a notification indicating an abnormality when the value obtained from the subtraction exceeds the threshold.

Another aspect of the present invention provides a contactless power receiving device that receives power in a contactless manner from a primary coil of a contactless power transmitting device and supplies the received power to a load. The contactless power receiving device includes a secondary coil that can be electromagnetically coupled to the primary coil of the contactless power transmitting device by alternating magnetic flux generated by the primary coil. A first temperature sensor detects a secondary coil proximity temperature. A second temperature sensor detects a temperature at a position that differs from where the first temperature sensor is located. A control unit determines whether or not a value obtained by subtracting the temperature detected by the second temperature sensor from the secondary coil proximity temperature detected by the first temperature sensor exceeds a predetermined threshold. The control unit issues a notification indicating an abnormality when the value obtained from the subtraction exceeds the threshold.

A further aspect of the present invention provides a contactless charging system including a contactless power transmitting device, which includes a primary coil that generates alternating magnetic flux, and a contactless power receiving device, which includes a secondary coil that can be electromagnetically coupled to the primary coil by the alternating magnetic flux generated by the primary coil. The contactless power receiving device receives power through the secondary coil. The system includes a first temperature sensor that detects a primary coil proximity temperature. A second temperature sensor detects a temperature at a position that differs from where the first temperature sensor is located. A control unit determines whether or not a value obtained by subtracting the temperature detected by the second temperature sensor from the primary coil proximity temperature detected by the first temperature sensor exceeds a predetermined threshold. The control unit stops supplying power to the primary coil or issues a notification indicating an abnormality when the value obtained from the subtraction exceeds the threshold.

In one example, the second temperature sensor is covered by a magnetic shield material.

In one example, the contactless power transmitting device includes the first temperature sensor and the second temperature sensor.

In one example, the second temperature sensor detects an ambient temperature outside the contactless power transmitting device at a position that differs from where the first temperature sensor is located.

In one example, the second temperature sensor detects an ambient temperature outside the contactless power transmitting device at a position separated from the primary coil.

In one example, the first temperature sensor detects a temperature in an electromagnetically coupled area.

In one example, the first temperature sensor and the second temperature sensor are located at positions determined so that when the alternating magnetic flux heats a metal foreign object proximal to the primary coil, the primary coil proximity temperature detected by the first temperature sensor rises and the ambient temperature detected by the second temperature sensor remains substantially the same.

### Effect of the Invention

The present invention can detect a metal foreign object without being affected by the usage environment.

### BRIEF DESCRIPTION OF THE DRAWINGS

FIG. 1 is a block diagram of a contactless charging system.

FIG. 2 is a timing chart showing changes in a primary coil proximity temperature and an ambient temperature when a metal foreign object is present.

### EMBODIMENT OF THE INVENTION

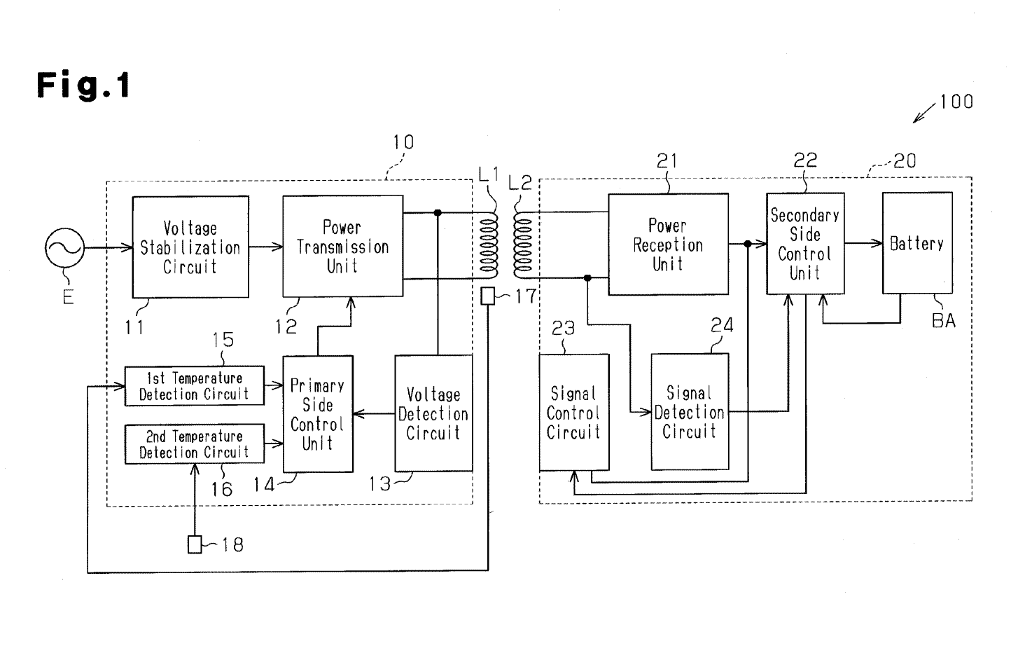

A contactless power transmitting device and a contactless charging system according to one embodiment of the present invention will now be described. As shown in FIG. 1, a contactless charging system 100 includes a contactless power transmitting device 10 and a power receiving device 20.

The contactless power transmitting device 10 will now be described. The contactless power transmitting device 10 includes a voltage stabilization circuit 11, a power transmission unit 12, a primary coil L1, a voltage detection circuit 13, and a primary side control unit 14. To detect a metal foreign object, the contactless power transmitting device 10 includes a first temperature detection circuit 15, a second temperature detection circuit 16, a first thermistor 17, and a second thermistor 18.

The voltage stabilization circuit 11 stabilizes the voltage of input power supplied from an external power supply E. The voltage stabilization circuit 11 is connected to the power transmission unit 12. The power transmission unit 12 generates AC power having a predetermined frequency when transmitting power. When transmitting a communication signal, the power transmission unit 12 generates AC power having a frequency that corresponds to the transmitted communication signal. For example, the power transmission unit 12 generates AC power having frequency f1 in correspondence with logic “1” of a communication signal and generates AC power having frequency f2 in correspondence with logic “0” of a communication signal. The power transmission unit 12 supplies the primary coil L1 with AC power for transmitting power or AC power for transmitting a signal.

The primary coil L1 generates alternating magnetic flux when supplied with AC power. The primary coil L1 transmits power when electromagnetically coupled to the secondary coil L2. The alternating magnetic flux has a frequency that corresponds to the frequency of the AC power. The voltage detection circuit 13 detects induced voltage at the primary coil L1. The voltage detection circuit 13 is connected to the primary side control unit 14. The voltage detection circuit 13 provides the primary side control unit 14 with a detection signal corresponding to the detected induced power (voltage). The primary coil L1 is also referred to as a power transmitting coil, and the secondary coil L2 is also referred to as a power receiving coil.

The primary side control unit 14 is mainly configured by a microcomputer or system LSI including a central processing unit (CPU) and a memory device (nonvolatile memory (ROM), volatile memory (RAM), and the like). Further, the primary side control unit 14 executes various types of controls, such as oscillation control of the power transmission unit 12, based on the various types of data and programs stored in a memory.

The primary side control unit 14 is connected to the power transmission unit 12. When the contactless power transmitting device 10 transmits a communication signal to the contactless power receiving device 20, the primary side control unit 14 provides the power transmission unit 12 with the communication signal that is to be transmitted (or the frequency corresponding to the transmitted communication signal) so that the power transmission unit 12 generates AC power having a frequency corresponding to the communication signal.

The primary side control unit 14 receives a detection signal from the voltage detection circuit 13, measures or calculates changes (waveform) of the induced voltage of the primary coil, and performs communication signal detection and foreign object detection. As will be described later, when the contactless power receiving device 20 transmits a communication signal to the contactless power transmitting device 10, a signal control circuit 23 of the contactless power receiving device 20 executes a load modulation process to transmit the communication signal. The load modulation process changes the waveform of the induced power at the primary coil L1 in the contactless power transmitting device 10. For example, when the contactless power receiving device 20 decreases the load used to transmit a communication signal of logic “0”, the amplitude of the waveform of the induced power at the primary coil L1 is decreased. When the contactless power receiving device 20 increases the load used to transmit a communication signal of logic “1”, the amplitude of the waveform of the induced power at the primary coil L1 is increased. The primary side control unit 14 can distinguish the type of the communication signal from whether not the peak voltage of the induced power exceeds a threshold. In a non-restrictive example, the primary side control unit 14 can demodulate electromagnetic induction type data communication from the contactless power receiving device 20, analyze the demodulated communication signal, and control oscillation (frequency) of the power transmission unit 12 based on the analysis result. The ROM of the primary side control unit 14 stores various types of thresholds and various types of parameters, which are used for demodulation of the electromagnetic type data communication with the contactless power receiving device 20 and analysis of the demodulated data communication as will be described later.

The primary side control unit 14 is connected to the first temperature detection circuit 15 and the second temperature detection circuit 16. The first temperature detection circuit 15 is connected to the first thermistor 17. The first thermistor 17 has an electrical resistance that is drastically changed by a slight change in the temperature. The first temperature detection circuit 15 provides the primary side control unit 14 with a temperature signal corresponding to the temperature detected by the first thermistor 17.

The first thermistor 17 detects a primary coil proximity temperature. In the illustrated example, the first thermistor 17 is arranged in the proximity of the primary coil L1. For example, the first thermistor 17 is arranged at a position at which it intersects with the alternating magnetic flux generated by the primary coil L1. The first thermistor 17 is arranged in a range affected by the heating of the metal foreign object that intersects with the alternating magnetic flux generated by the primary coil L1. When a metal foreign object is present in the proximity of the primary coil L1, the alternating magnetic flux of the primary coil L1 generates eddy current at the metal foreign object. This may heat the metal foreign object. The primary coil proximity temperature detected by the first thermistor 17 rises when the metal foreign object is heated. The first thermistor 17 is one example of a first temperature sensor or a first temperature sensor element. The primary coil proximity temperature may be referred to as the temperature of an electromagnetic coupling area, which is an area in which power can be supplied from the contactless power transmitting device 10 to the contactless power receiving device 20.

The second temperature detection circuit 16 is connected to the second thermistor 18. The second thermistor 18 has an electrical resistance that is drastically changed by a slight change in the temperature. The second temperature detection circuit 16 provides the primary side control unit 14 with a temperature signal corresponding to the temperature detected by the second thermistor 18. The second thermistor 18 is arranged at a position that differs from where the first thermistor 17 is located. In the illustrated example, the second thermistor 18 is arranged at a position that is separated from the primary coil L1 and not affected by the primary coil L1. In further detail, the second thermistor 18 is arranged at a position where it does not intersect with the alternating magnetic flux generated by the primary coil L1. That is, even when a metal foreign object that intersects with the alternating magnetic flux generated by the primary coil L1 is heated, the second thermistor 18 is arranged in an unaffected range. For example, the second thermistor 18 may be arranged at a position separated from the first thermistor 17 or on an outer surface of the contactless power transmitting device 10 that is opposite to the surface in which the first thermistor 17 is arranged. The second thermistor 18 detects the peripheral temperature (ambient temperature) at a position that is not affected by the alternating magnetic flux generated by the primary coil L1. The second thermistor 18 is one example of a second temperature sensor or a second temperature sensor element.

The contactless power receiving device 20 will now be described. The contactless power receiving device 20 includes a secondary coil L2, which receives alternating magnetic flux from the contactless power transmitting device 10, a power reception unit 21, a secondary side control unit 22, a signal control circuit 23, a signal detection circuit 24, and a battery BA.

The power reception unit 21 includes a rectification circuit that converts AC power (induced power), which flows to the secondary coil L2 when the secondary coil receives alternating magnetic flux, into DC power. The rectification circuit includes a rectification diode and a smoothing capacitor, which smoothes the power rectified by the rectification diode. Further, the rectification circuit is configured as the so-called half-wave rectification circuit that converts the AC power supplied from the secondary coil L2 into DC power. The configuration of the rectification circuit is just one example of a rectification circuit that converts AC power into DC power, and the rectification circuit is not restricted to this configuration and may have the configuration of a full-wave rectification circuit, which uses a diode bridge, or other known rectification circuits. The signal detection circuit 24 detects the induced power of the secondary coil L2. Further, the signal detection circuit 24 is connected to the secondary side control unit 22 and provides the secondary side control unit 22 with a waveform of the detected induced power (voltage).

When the contactless power receiving device 20 transmits a communication signal to the contactless power transmitting device 10, the signal control circuit 23 performs a load modulation process that changes the load applied to the secondary coil L2 in accordance with the transmitted communication signal. The load modulation process changes the waveform of the induced power at the primary coil L1 through the secondary coil L2. The signal control circuit 23 is connected to the secondary side control unit 22 and performs the load modulation process based on a control signal from the secondary side control unit 22.

The secondary side control unit 22 is mainly configured by a microcomputer including a central processing unit (CPU) and a memory device (ROM, RAM, and the like). Further, based on various types of data and programs stored in a memory, the secondary side control unit 22 determines the state of charge of the battery BA, which is included in the contactless power receiving device 20, and executes various types of controls, such as charge amount control of the battery BA. In the present embodiment, a communication signal to the contactless power transmitting device 10 is generated based on the charge amount of the battery BA. The ROM of the secondary side control unit 22 stores in advance various types of information for the charge amount control including the determination of the charge amount of the battery (present load) BA and various types of parameters used to generate a communication signal and perform modulation based on the communication signal.

The secondary side control unit 22, which is connected to the positive electrode and negative electrode of the battery BA, can receive driving power from the battery BA. The secondary side control unit 22 can calculate the charge amount of the battery BA from, for example, the voltage between the terminals of the battery BA. The secondary side control unit 22 adjusts the AC power supplied from the power reception unit 21 to a predetermined voltage to generate and supply the battery BA with charging power. The secondary side control unit 22 switches between states supplying and stopping the charging power in accordance with the charge amount of the battery BA. For example, when the voltage between the terminals of the battery BA is less than a preset charge amount determination threshold and the secondary side control unit 22 determines that the charging of the battery BA is preferable, the secondary side control unit 22 supplies charging power to the battery BA. When the voltage between the terminals of the battery BA is greater than or equal to the charge amount determination threshold, the secondary side control unit 22 determines that there is no need to charge the battery BA and stops supplying charging power to the battery BA.

Further, when the operation voltage is lower than the voltage that allows for operation, the secondary side control unit 22 disconnects the battery BA and prevents a reverse flow of current from the battery BA. The secondary side control unit 22 monitors the frequency of the induced power at the secondary coil L2 and determines whether a communication signal from the contactless power transmitting device 10 is logic “1” or logic “0”.

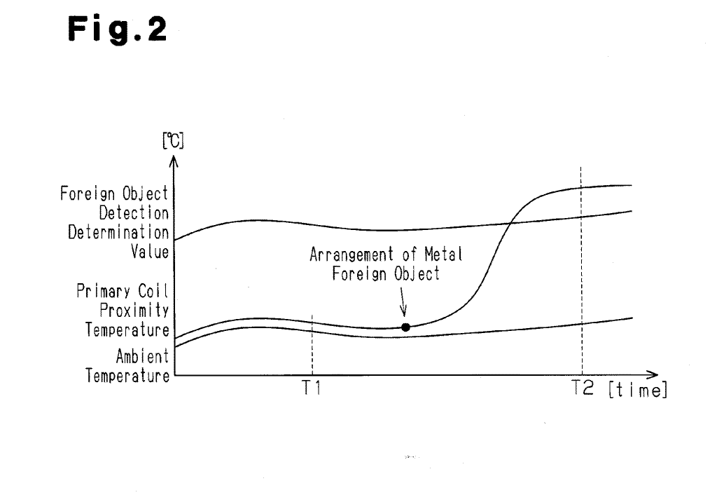

The detection of a metal foreign object in the proximity of the primary coil L1 will now be described with reference to FIG. 2.

The first temperature detection circuit 15 provides the primary side control unit 14 with a temperature signal corresponding to the primary coil proximity temperature detected by the first thermistor 17. The second temperature detection circuit 16 provides the primary side control unit 14 with a temperature signal corresponding to the ambient temperature detected by the second thermistor 18.

In accordance with the temperature signals provided from the first temperature detection circuit 15 and the second temperature detection circuit 16, the primary side control unit 14 determines whether or not the detected primary coil proximity temperature is greater than or equal to a predetermined threshold. That is, the primary side control unit 14 determines whether or not a value obtained by subtracting the ambient temperature from the primary coil proximity temperature, which are detected at the same time, is greater than or equal to a predetermined threshold. In another example, the primary side control unit 14 determines whether or not the detected primary coil proximity temperature is greater than or equal to the sum of the detected ambient temperature and a predetermined threshold. FIG. 2 shows the temperature obtained by adding a detected ambient temperature to a predetermined threshold as an abnormality detection determination value. The abnormality detection determination value changes in accordance with the detected ambient temperature.

The predetermined threshold is the temperature difference between the primary coil proximity temperature and the ambient temperature when a metal foreign object is heated. When a metal foreign object is heated, the temperature difference between the primary coil proximity temperature and the ambient temperature may change depending on the size, shape, and material of the metal foreign object, the distance from the first thermistor 17 to the metal foreign object, and the like. The predetermined threshold is set by conducting experiments to obtain measurements of the primary coil proximity temperature allowing for assumption that there is a high probability of a metal foreign object being present.

When a value obtained by subtracting the ambient temperature from the primary coil proximity temperature, which are detected at the same time, is not greater than or equal to a predetermined threshold (refer to time T1 in FIG. 2), the primary side control unit 14 determines that the metal foreign object has no heating influence.

When a value obtained by subtracting the ambient temperature from the primary coil proximity temperature is greater than or equal to a predetermined threshold (refer to time T2 in FIG. 2), the primary side control unit 14 determines that the heating of the metal foreign object has affected and increased the primary coil proximity temperature. In this case, the primary side control unit 14 stops supplying power to the primary coil L1. Further, at the same time, the primary side control unit 14 controls a notification unit, which is arranged in the contactless power transmitting device 10, to issue a notification indicating that a metal foreign object is present.

As described above in detail, the present embodiment has the advantages described below.

(1) In the present embodiment, the primary side control unit 14 determines whether or not a metal foreign object is present based on whether or not the difference of the primary coil proximity temperature and the ambient temperature is greater than or equal to a predetermined threshold. When the ambient temperature changes, the primary coil proximity temperature changes accordingly as long as a metal foreign object is not present. In contrast, when the ambient temperature does not change but a metal foreign object is present, the primary coil proximity temperature differs from the ambient temperature, and the metal foreign object can be detected. Thus, a metal foreign object can be detected regardless of the ambient temperature.

(2) When detecting a metal foreign object, the primary side control unit 14 stops supplying power to the primary coil L1. This prevents the supply of unnecessary power and suppresses heating of the metal foreign object. Further, when detecting a metal foreign object, the primary side control unit 14 controls the notification unit and issues a notification indicating the presence of a metal foreign object. Thus, the presence of a metal foreign object can be notified. The notification unit may be a display, a buzzer, a vibrator, or the like.

(3) The first thermistor 17 is arranged at a position that can be reached by the alternating magnetic flux generated by the primary coil L1. Thus, when a metal foreign object is present, the heating of the metal foreign object can be detected. Further, the second thermistor 18 is arranged at a position that cannot be reached by the alternating magnetic flux generated by the primary coil L1. Thus, when a metal foreign object is present, the ambient temperature can be detected without being affected by the heating of the metal foreign object.

The above embodiment may be modified as described below.

In the above embodiment, when a metal foreign object is detected, the primary side control unit 14 stops supplying power to the primary coil L1 and controls the notification unit to issue a notification indicating an abnormality. However, the primary side control unit 14 may perform just either one of these two actions. For example, when detecting a metal foreign object, the primary side control unit 14 may just stop supplying power to the primary coil L1.

In the above embodiment, the AC power of the primary coil L1 in a standby state (power save mode) may be freely changed as long as it is smaller than the AC power when charge power is transmitted.

In the above embodiment, when the primary coil proximity temperature is greater than or equal to a predetermined temperature, the primary side control unit 14 may determine that a metal foreign object is present, stop the supply of power to the primary coil L1, and control the notification unit to issue a notification indicating an abnormality.

In the above embodiment, the first temperature detection circuit 15, the first thermistor 17, the second temperature detection circuit 16, and the second thermistor 18 are included in the contactless power transmitting device 10 but may be included in a contactless power receiving device. In this case, the secondary side control unit 22 detects a foreign metal object based on a secondary coil proximity temperature and an ambient temperature.

In the above embodiment, the primary coil proximity temperature and ambient temperature can be detected by components other than the thermistors 17 and 18.

In the above embodiment, the secondary side control unit 22 receives driving power from the battery BA. However, the driving power may be supplied from the power reception unit 21.

In the above embodiment, the second thermistor 18 may be covered by a magnetic shield material so that it is not affected by the alternating magnetic flux generated by the primary coil L1. Further, by covering the second thermistor 18 with a magnetic shield material, the influence of the alternating magnetic flux can be reduced. Thus, in comparison with when not covered by a magnetic shield material, the second thermistor 18 can be arranged closer to a range that intersects with the alternating magnetic flux. This allows for the contactless power transmitting device 10 to be reduced in size. The magnetic shield material only needs to reduce the influence of alternating magnetic flux and amorphous or ferrite is preferred.

### DESCRIPTION OF THE REFERENCE CHARACTERS

100: contactless charging system
10: contactless power transmitting device
11: voltage stabilization circuit
12: power transmission unit
13: voltage detection circuit
14: primary side control unit
15: first temperature detection circuit
16: second temperature detection circuit
17: first thermistor
18: second thermistor
20: contactless power receiving device
21: power reception unit
22: secondary side control unit
23: signal control circuit
24: signal detection circuit
BA: battery
L1: primary coil
L2: secondary coil

1. A contactless power transmitting device that supplies power in a contactless manner to a contactless power receiving device, the contactless power transmitting device comprising:
a primary coil that generates alternating magnetic flux, wherein the primary coil can be electromagnetically coupled by the alternating magnetic flux to a secondary coil of the contactless power receiving device;
a first temperature sensor that detects a primary coil proximity temperature;
a second temperature sensor that detects a temperature at a position that differs from where the first temperature sensor is located;
a control unit that determines whether or not a value obtained by subtracting the temperature detected by the second temperature sensor from the primary coil proximity temperature detected by the first temperature sensor exceeds a predetermined threshold, wherein the control unit stops supplying power to the primary coil or issues a notification indicating an abnormality when the value obtained from the subtraction exceeds the threshold.

2. A contactless power receiving device that receives power in a contactless manner from a primary coil of a contactless power transmitting device and supplies the received power to a load, the contactless power receiving device comprising:
a secondary coil that can be electromagnetically coupled to the primary coil of the contactless power transmitting device by alternating magnetic flux generated by the primary coil;
a first temperature sensor that detects a secondary coil proximity temperature;
a second temperature sensor that detects a temperature at a position that differs from where the first temperature sensor is located;
a control unit that determines whether or not a value obtained by subtracting the temperature detected by the second temperature sensor from the secondary coil proximity temperature detected by the first temperature sensor exceeds a predetermined threshold, wherein the control unit issues a notification indicating an abnormality when the value obtained from the subtraction exceeds the threshold.

3. A contactless charging system comprising:
a contactless power transmitting device including a primary coil that generates alternating magnetic flux;
a contactless power receiving device including a secondary coil that can be electromagnetically coupled to the primary coil by the alternating magnetic flux generated by the primary coil, wherein the contactless power receiving device receives power through the secondary coil;
a first temperature sensor that detects a primary coil proximity temperature;
a second temperature sensor that detects a temperature at a position that differs from where the first temperature sensor is located; and
a control unit that determines whether or not a value obtained by subtracting the temperature detected by the second temperature sensor from the primary coil proximity temperature detected by the first temperature sensor exceeds a predetermined threshold, wherein the control unit stops supplying power to the primary coil or issues a notification indicating an abnormality when the value obtained from the subtraction exceeds the threshold.

4. The contactless charging system according to claim 3, wherein the second temperature sensor is covered by a magnetic shield material.

5. The contactless charging system according to claim 3, wherein the contactless power transmitting device includes the first temperature sensor and the second temperature sensor.

6. The contactless power transmitting device according to claim 1, wherein the second temperature sensor detects an ambient temperature outside the contactless power transmitting device at a position that differs from where the first temperature sensor is located.

7. The contactless power transmitting device according to claim 1, wherein the second temperature sensor detects an ambient temperature outside the contactless power transmitting device at a position separated from the primary coil.

8. The contactless power transmitting device according to claim 1, wherein the first temperature sensor detects a temperature in an electromagnetically coupled area.

9. The contactless power transmitting device according to claim 6, wherein the first temperature sensor and the second temperature sensor are located at positions determined so that when the alternating magnetic flux heats a metal foreign object proximal to the primary coil, the primary coil proximity temperature detected by the first temperature sensor rises and the ambient temperature detected by the second temperature sensor remains substantially the same.
